(19) United States
(12) Patent Application Publication
(10) Pub. No.: US 2012/0189122 A1
(43) Pub. Date: Jul. 26, 2012

(54) METHOD WITH DYNAMIC KEYS FOR MUTUAL AUTHENTICATION IN WIRELESS COMMUNICATION ENVIRONMENTS WITHOUT PRIOR AUTHENTICATION CONNECTION

(76) Inventors: Yi-Li Huang, Taichung City (TW); Fang-Yie Leu, Taichung County (TW)

(21) Appl. No.: 12/939,465

(22) Filed: Jan. 20, 2011

(51) Int. Cl. H04L 9/00

(52) U.S. Cl. 380/270

(57) ABSTRACT

A mutual authentication method with which a base station and a subscriber station can mutually authentication with each other is proposed. In this method, dynamic keys are employed, and SS and BS individually input random numbers to the Diffie-Hellman Public Key Distribution System (DH-PKDS for short) to generate a set of public keys and a set of common secret keys as the strong data connection for authentication (DCA for short) between the two stations. An addition function (ADR) which is more secure than that of an exclusive OR function in key transmission is used as a data carrier. SS and BS authenticate each other by using the identity certification keys. Plaintext is encrypted by a two-dimensional stream cipher method so that ciphertext can be more securely, also efficiently, transmitted. Further, dynamic keys and all other security parameters transmitted through wireless channels are only used once to further improve system security.

### FIELD OF THE INVENTION

The present invention relates to a communication method in wireless communication environment, and particularly to a wireless communication method with dynamic keys for mutual authentication.

### BACKGROUND OF THE INVENTION

The wireless communication mainly comprises the cell phone communication and the wireless network communication. However, in an environment using 802.16e PKMv1, there is no data connection (common basic data) before SS (Subscriber Station) end and BS (Base Station) end commence the wireless communication, which is different from the data connection of IMSI and Ki on the SIM card in a cell phone or the data connection between SS and AAA (Authentication-Authorization-Accounting) in PKMv2 of IEEE 802.16e. Currently, all the data connections between SS end and BS end should be established by transmitting data through wireless communication. If the data in wireless communication is not protected by excellent security mechanism in the beginning, the data connection established between SS end and BS end will not be secure, and the security of the whole wireless communication system will be vulnerable accordingly.

Take the current IEEE 802.16e PKMv1 as an example for illustration. The wireless communication in IEEE 802.16e PKMv1 will execute the following steps:

```
    PART  : (PKM Authorization)
    Message 1:
    SS→BS: Cert(Manufacturer(SS))
    Message 2:
    SS→BS: Cert(SS) | Capabilities | SAID
    Message 3:
    BS→SS: RSA-Encrypt(PubKey(SS),AK) | Lifetime | SeqNo
| SAIDList
    PART  : (Privacy and key management)
    Message 1:
    BS→SS: SeqNo | SAID | HMAC(1)
    Message 2:
    SS→BS: SeqNo | SAID | HMAC(2)
    Message 3:
    BS→SS: SeqNo | SAID | OldTEK | NewTEK | HMAC(3)
```

In the above process of PKMv1 wireless communication, there are at least three security vulnerabilities described as follows: (1) In PART I (PKM authorization) wireless communication, because the data connection has not been established between SS and BS, and there is no authentication function from SS to BS in the transmitted data of Message 3, it is easy for a hacker to act as a fake BS and transmit a fake Message 3 to the SS. Furthermore, owing to the absence of the authentication function, the SS may receive the fake message anyway, and the SS will retrieve incorrect AK and then cause the failure of authentication of HAMC(1)˜HAMC(3) in the following PART II wireless communication; (2) Now that there are six wireless transmissions between SS and BS since SS sends out message to request the wireless communication until it retrieves TEKs, the hacker can easily interfere with the wireless communication between SS and BS, and further intercept information or affect the wireless communication. Thus, reduction of times of wireless transmission between SS and BS is also one of the methods for improving security; and (3) Because the protection by PubKey(SS) is not very strict and secure, the hacker can retrieve PubKey(SS) of SS from Cert(SS) in Message 2 of PART I, and further retrieve AK sent by BS from Message 3 of PART I, or even retrieve multiple RSA-Encrypt(PubKey(SS),AK) from Message 3 of PART I in the multiple wireless connection requests submitted by the same SS, and further retrieve PubKey(SS) by analyzing these multiple RSA-Encrypt(PubKey(SS), AKs). After the hacker retrieved the Authentication Key (AK), all the transmitted data between SS and BS in PART II are dangerous, because <a> the hacker can easily retrieve OldTEK and NewTEK, and all the following data transmission will be easily cracked by the hacker, consequently losing the security at all; and <b> the hacker may act as a fake SS to communicate with BS, and may also act as a fake BS to communicate with SS, so that the communication data transmitted between BS and SS will be completely retrieved by the hacker, and then the personal data of SS may be stolen, which may cause severe damage to SS.

In order to improve the intrinsic security defects of IEEE 802.16e PKMv1 in wireless communication, the process of wireless communication has been improved as follows:

```
    PART  : (PKM Authorization)
    Message 1:
    SS→BS: Cert(Manufacturer(SS))
    Message 2:
    SS→BS: SS-Random | Cert(SS) | Capabilities | SAID
    Message 3:
    BS→SS: SS-Random | BS-Random |
    RSA-Encrypt(PubKey(SS),pre_AK) |
    Lifetime | SeqNo | SAIDList | Cert(BS) | Sig(BS)
    PART  : (Privacy and key management)
    Message 1:
    BS→SS: SS-Random | BS-Random | SeqNo12 | SAID | HAMC(1)
    Message 2:
    SS→BS: SS-Random | BS-Random | SeqNo12 | SAID | HMAC(2)
    Message 3:
    BS→SS: SS-Random | BS-Random | SeqNo12 | SAID | OldTEK |
NewTEK | HMAC(3)
```

This improvement method mainly adds the following in the process of wireless communication: (1) adding the random parameters, SS-Random and BS-Random; (2) replacing AK with Pre_AK and sending Pre_AK to SS from BS, and SS then generates AK based on a formula (described later), thus preventing from directly transmitting encrypted AK in a packet/message; (3) adding the random parameters, SS-Random and BS-Random, in the formula generating AK and TEK so as to provide these formulas with random characteristic, which may increase the difficulty for the hacker's cracking. However, in the entire process of wireless communication, the mutual authentication mechanism is not been established. All the random parameters only give randomness to the generation of AK and TEK. Nevertheless, SS-Random and BS-Random are directly retrieved from the wireless packets/messages without any encryption protection, so that the hacker will easily retrieve both of them from the intercepted packets/messages. Therefore, this method substantially is not very helpful to the security; and (4) Since the variables required for the formula generating AK and TEK, including pre_AK, SS-Random, BS-Random, SS-MAC-Addr, BS-MAC-Addr and pre-TEK, etc., can be all retrieved directly or indirectly by the hacker in the process of wireless communication for authentication, the system security will not be significantly improved. In fact, such a modification provides only limited improvement to the intrinsic security defects of wireless communication for the entire IEEE 802.16e PKMv1, the modification cannot be construed as a successful example and need to be greatly improved.

As described above, the basic requirement for a secured wireless communication system is that each wireless communication steps should be authenticated, and the parameters for each wireless communication steps should be abandoned once used, but it is difficult to achieve this requirement under the environment of IEEE 802.16e PKMv1.

The present invention integrates Diffie-Hellman public key distribution system (Diffie-Hellman PKDS for short), Identity Certification Key, Data Carriers and Mutual Authentication mechanism, etc., so as to establish a securely dynamic key system between SS end and BS end. With the operation of this system mechanism, even under the environment of IEEE 802.16e PKMv1, any wireless communication between SS end and BS end should be able to have mutual authentication, and all the keys and parameters used shall be exposed in the wireless packet/message only once, which greatly enhances the security of wireless communication.

### SUMMARY OF THE INVENTION

In view of the defects for the above-mentioned wireless communication method, the Inventor provides a method with dynamic keys for mutual authentication in wireless communication, so that each two-way wireless communication between SS and BS has to pass the authentication mechanism, and the data in wireless communication can be further processed only after passing the authentication, so as to achieve the purpose of enhancing the security of wireless communication.

To this end, the wireless communication method according to the present invention includes: a method with dynamic keys for mutual authentication in wireless communication. An authentication message comprises: an OP_code as the head of the transmitted message, a nonce of SS (N_{SS}), a set of SS random numbers as the SS's private keys. The set of private keys are inputted into a Diffie-Hellman PKDS function to generate a set of SS public keys, and the SS will transmit a wireless communication authentication request message that contains the set of SS public keys to a BS. The HMAC(PubKey(SS)) is involved for the integrity of the transmitted message. The BS on receiving the authentication request message from SS retrieves the PubKey(SS) from the Cert(SS) contained in the massage. BS determines whether the HMAC(PubKey(SS)) sent by SS and HMAC(PubKey(SS)) calculated inside the BS are equal or not? If not, BS discards the fake message. Otherwise, BS further compares the N_{SS} sent by SS and the nonce of BS (i.e., N_{BS}) immediately. If N_{BS}−N_{SS} is greater than 30 seconds, then BS discards the suspected replay attack message. Otherwise BS randomly selects a set of BS random numbers as the private keys of BS corresponding to the SS, and input the private keys into a Diffie-Hellman PKDS function to generate a set of BS public keys. Next the BS employs the set of SS public keys transmitted by the SS and the BS private keys to calculate and generate a set of Common Secret Keys, CSK1, CSK2 and CSK3 and further calculates and generates a set of BS's first identity certification keys, i.e., Cerfun(PubKey(SS), CSK1, CSK2), from the retrieved set of Common Secret Key. After that the BS transmits an authentication-success message that contains the BS's first identity certification key to the SS, and subsequently, the BS independently calculates and generates a set of BS Authentication Keys (AKs), a set of BS Traffic Encryption Keys (TEKs) and a set of BS New Traffic Encryption Keys (NTEKs).

The SS receiving a packet/message from the BS retrieves the OP_code from the packet/message. From the OP-code, the SS can realize that this is an authentication-success message containing the identity certification key. Next, the SS employs the SS private keys and the set of BS public keys transmitted by BS to calculate and generate a set of Common Secret Keys, i.e., CSK1, CSK2, CSK3. The SS further calculates and generates a set of SS's first identity certification keys, i.e., Cerfun(PubKey(SS), CSK1, CSK2), from the retrieved set of Common Secret Keys, and compares the calculated set of SS's first identity certification keys with the BS's identity certification keys transmitted by the BS to see if they are equal or not. If yes, the SS will independently calculate and generate a set of SS Authentication keys (AKs), a set of SS Traffic Encryption Keys (TEKs), and a set of SS New Traffic Encryption Keys (NTEKs). The SS transmits a data transmission request message that contains the SS's second identity certification key, i.e., Cerfun(AK1, AK2, AK3), to the BS. The BS on receiving the request message checks to see whether the SS's second identity certification key transmitted by the SS is equal to the set of BS's second identity certification keys calculated and generated inside the BS. If they are equal, the BS will return a permit data transmission message containing the BS's third identity certification key, i.e., Cerfun(AK4, AKS, AK6), to the SS. The SS on receiving the permit data transmission message from the BS authenticates the BS by checking to see whether the BS's third identity certification key transmitted by the BS and the SS's third identity certification key calculated and generated inside the SS are equal or not. If yes, the SS will encrypt a plaintext data into a ciphertext, and transmit the ciphertext and the SS authentication code, i.e., EXOR(TEKm, NTEKm), calculated and generated with the set of SS Traffic Encrypt Keys (TEKs) and the set of SS New Traffic Encrypt Keys (NTEKs), to the BS. The BS on receiving the ciphertext and the SS authentication code from the SS checks to see whether the SS authentication code, i.e., EXOR(TEKm, NTEKm), received from the SS and the BS authentication code, i.e., EXOR(TEKm, NTEKm), calculated and generated with the set of BS authentication keys (TEKs) and the set of BS New Traffic Encrypt Keys (NTEKs) generated inside the BS are equal or not. If yes, the ciphertext will be decrypted into a plaintext data. Thus, the method with dynamic keys for mutual authentication in wireless communication according to the present invention can enhance the security of wireless communication.

### BRIEF DESCRIPTION OF DRAWINGS

FIG. 1 shows a flow diagram of an embodiment according to the present invention;

FIG. 2 is a flow diagram continuing from FIG. 1;

FIG. 3 is a flow diagram continuing from FIG. 2;

FIG. 4 is a flow diagram continuing from FIG. 3;

FIG. 5 is a flow diagram continuing from FIG. 4; and

FIG. 6 is an OP_code function lookup table of an embodiment according to the present invention.

### DETAILED DESCRIPTION OF PREFERRED EMBODIMENTS

In order to fully understand the object, features and functions of the present invention are described below in details with the following embodiments which refer to the accompany drawings as follows:

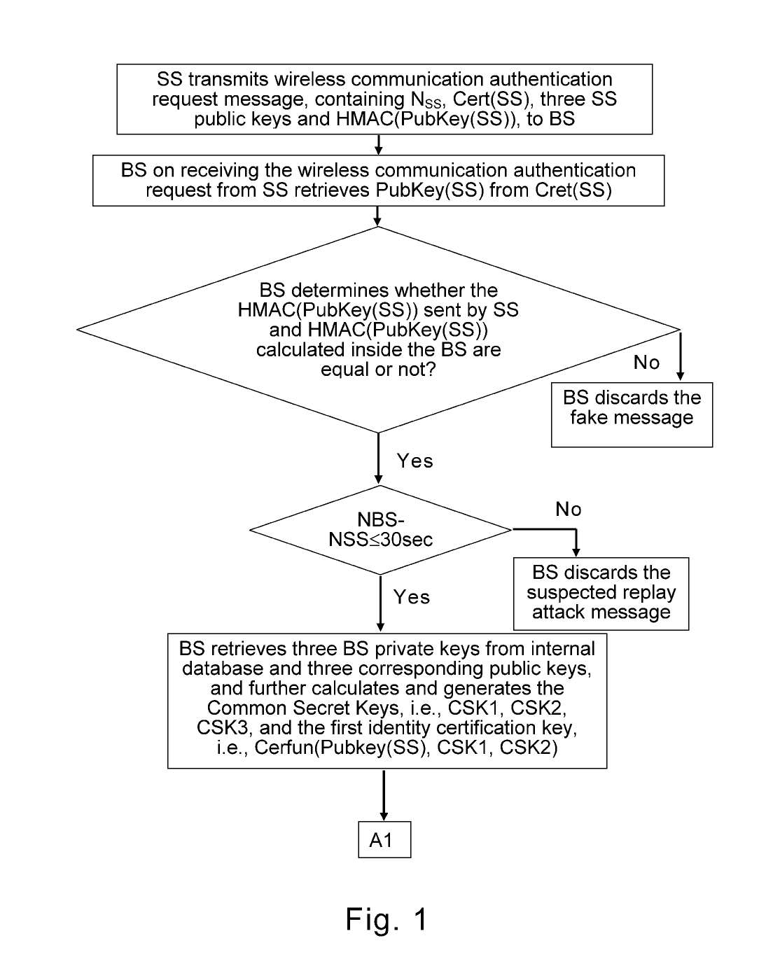

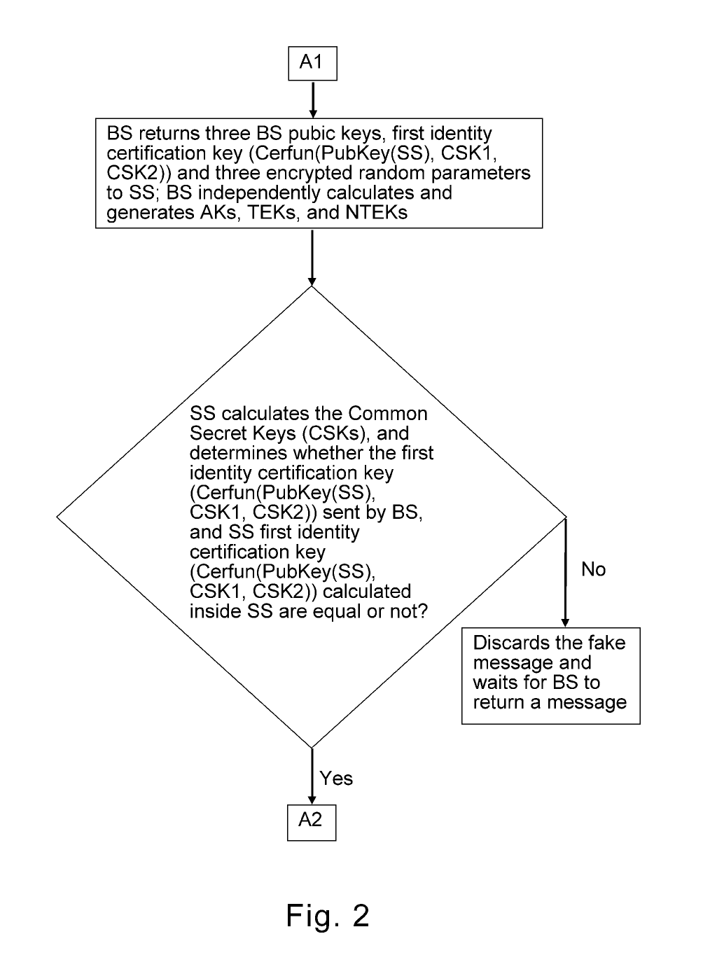

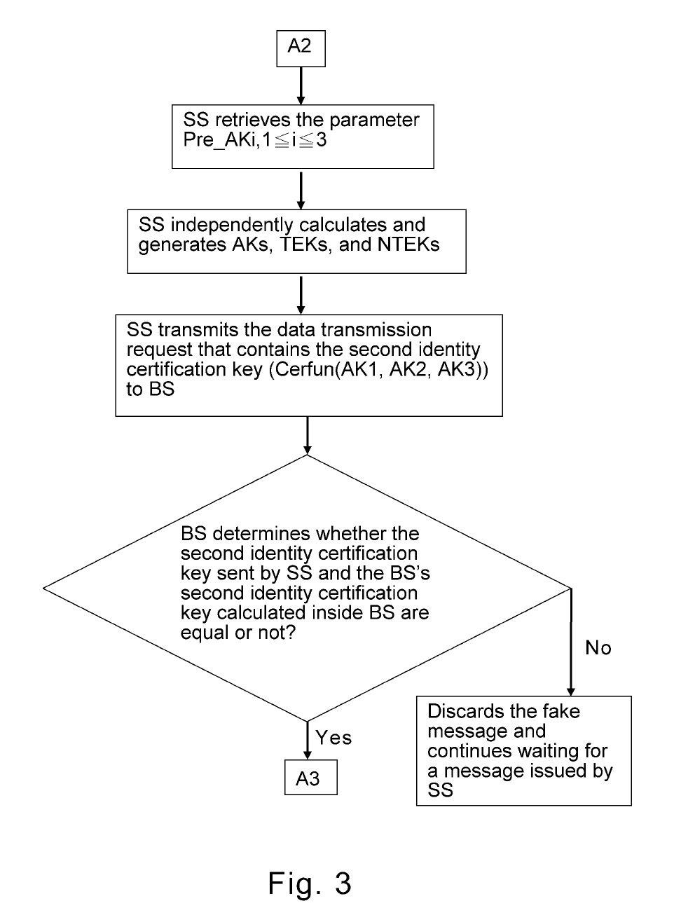

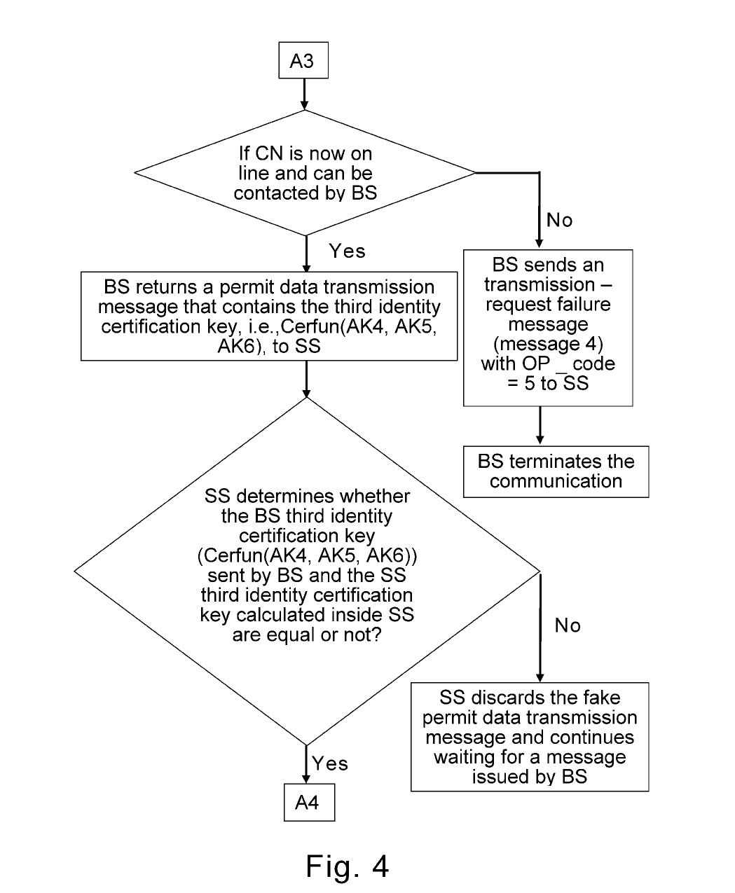

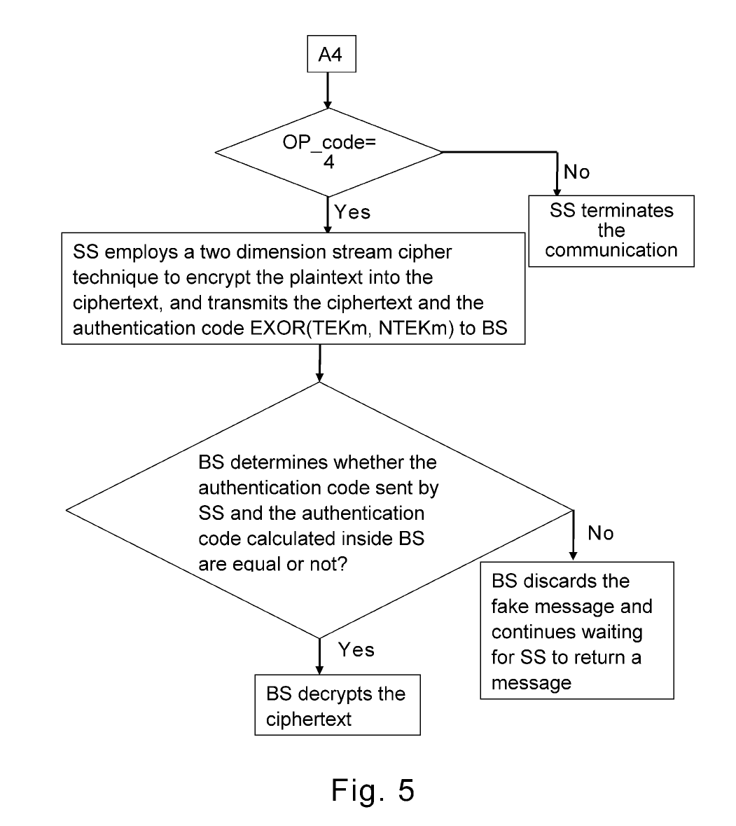

Please refer to FIG. 1 to FIG. 5, which are respectively a flow diagram of an embodiment according to the present invention, a flow diagram continuing from FIG. 1, a flow diagram continuing from FIG. 2, a flow diagram continuing from FIG. 3 and a flow diagram continuing from FIG. 4.

The operation of the proposed method consists of 10 steps, in which Step 1 through Step 4 are the authentication phase. Step 5 through Step 8 belong to the pre_data transmission phase, and the last two steps constitute the data transmission phase.

The authentication phase: This phase is involved to exchange keys for authentication, and set up data connection for authentication (DCA for short) for SS and BS.

Step 1: SS first self-produces three random numbers, SR1, SR2, and SR3, as its private keys, with which it generates three public keys P_{SR1}, P_{SR2} and P_{SR3} where P_{BRi}=g^{BRi} mod P, 1≦i≦3. It then sends an authentication-request message, i.e., message 1, with OP_code=1 to BS. The format of the authentication-request message (message 1) is:

OP_code|N_{SS}|Cert (SS)|P_{SR1}|P_{SR2}|P_{SR3}|HMAC PubKey (SS))

Step 2: BS on receiving the message retrieves the PubKey(SS) from Cert(SS) determines whether the HMAC(PubKey(SS)) sent by SS and HMAC(PubKey(SS)) calculated inside the BS are equal or not. If not, BS discards the fake message. Otherwise, BS further compares the N_{SS} sent by SS and the nonce of BS (i.e., N_{BS}) immediately. If N_{BS}−N_{SS} is greater than 30 seconds, then BS discards the replay attack message. Otherwise BS randomly selects three random numbers BR1, BR2, and BR3 from its pre-produced internal random number table as its private keys, and retrieves the three corresponding public keys P_{BR1}, P_{BR2} and P_{BR3}, which are calculated beforehand, also from the table where P_{BRi}=g^{BRi} mod P,1≦i≦3. After that, it generates the three common secret keys CSK1, CSK2 and CSK3 where

$$CSKi = {P}_{SRi}^{BRi} mod P , 1 \leq i \leq 3 ,$$

and the identity certification key Cerfun(PubKey(SS),CSK1,CSK2). The PubKey(SS) and the three common secrete keys are employed as the DCA between SS and BS.

Step 3: BS selects another three random numbers as pre_AK1, pre_AK2, and pre_AK3 from its internal random number table, and sends an authentication/key reply message, i.e., message 2, with OP_code=2 to SS. The format of the authentication/key reply message (message 2) is:

OP_code | P_{BR1} | P_{BR2} | P_{BR3} | Cerfun (PubKey (SS), CSK 1, CSK 2) |
ADR (CSK 1,pre_AK 1) | ADR (CSK 2,pre_AK 2) | ADR
(CSK 3,pre_AK 3)

Meanwhile, BS produces

```
      (1) six AKs, i.e., AK1 ~ AK6, by using HMAC-SHA algorithm
where
  AK1 = HMAC − SHA(CSK1,pre_AK1 | CSK 2 | pre_AK 2 | PubKey (SS) | BS_MAC_Addr )
  AK2 = HMAC − SHA(CSK2,pre_AK2 | CSK3 | pre_AK3 | PubKey(SS)|SS_MAC_Addr)
  AK3 = HMAC − SHA(CSK3,pre_AK3 | CSK1 | pre_AK1 | PubKey(SS)|BS_MAC_Addr)
  AK 4 = HMAC − SHA(CSK 1,CSK 2 | CSK 3 | pre_AK 1 | PubKey (SS)|SS_MAC_Addr )
  AK 5 = HMAC − SHA(CSK 2,CSK 3 | CSK 1 | pre_AK 2 | PubKey (SS)|BS_MAC_Addr )
  AK 6 = HMAC − SHA(CSK 3,CSK 1 | CSK 2 | pre_AK 3 | PubKey (SS)|SS_MAC_Addr )
      (2) 243 TEKs, i.e., TEK1 ~ TEK243, where
    TEK_{(i-1)×81+(j-1)×9+k} = (AKᵢ ⊕ TAKⱼ) + TCKₖ,4 ≦ i ≦ 6,1 ≦ j,k ≦ 9
      in which
      TAK_{( i - 1 ) × 3 + j} = AKi + pre_AKj ,1 ≦ i , j ≦ 3 , and
      TCK_{( i - 1 ) × 3 + j} = CSKi + pre_AKj ,1 ≦ i , j ≦ 3 .
      (3) 243 NTEKs, i.e., NTEK1 ~ NTEK243,, where
    NTEK_{(i-1)×81+(j-1)×9+k} = (AKᵢ ⊕ NTAKⱼ) + (NTCKₖ ⊕ AK 6),1 ≦ i ≦ 3,1 ≦ j,k ≦ 9.
      is which
        NTAKᵢ = AK 4 ⊕ TAKᵢ,1 ≦ i ≦ 9, and
        NTCKⱼ = AK 5 ⊕ TCKⱼ,1 ≦ j ≦ 9.
```

Here, the 6AKs, 243TEKs, 9TAKs, 9TCKs, 243NTEKs, 9NTAKs, and 9NTCKs are together called TEK-key group.

Step 4: SS on receiving of the message retrieves P_{BR1}, P_{BR2} and P_{B} [symbol] from the message, and calculates CSKi,

$$CSKi = {P}_{BRi}^{SRi} mod P , 1 \leq i \leq 3 ,$$

and the identity certification key Cerfun(PubKey(SS),CSK1,CSK2). SS authenticates BS by comparing the retrieved Cerfun (PubKey(SS), CSK1, CSK2) and the calculated one. If they are not equal, SS discards the fake message and waits for an authentication/key reply message issued by a valid BS. Otherwise, it recovers pre-AKi by invoking the reverse function of the data carriers ADR (CSKi, pre_AKi),i=1,2,3. With the identity certification key, we can not only defend the forgery BS attacks, but also well protect PubKey(SS). The forgery BS attacks that the PKMv1 suffers are then solved.

The pre_data transmission phase: This phase is involved to establish the links between SS and BS and between BS and the correspondent node (CN for short).

Step 5: SS produces the corresponding TEK-key group by using the same functions defined above. SS further sends a data-transmission-request message, i.e., message 3, with OP_code =3 to BS. The format of the data transmission request message (message 3) is:

OP_Code | Cerfun (AK 1,AK 2,AK 3)

Step 6: BS on receipt of the message authenticates the message by comparing Cerfun(AK1,AK2,AK3) calculated and the one retrieved from the message. If they are not equal, BS discards the fake message and waits for a data-transmission-request message issued by the valid SS. Otherwise it proceeds to the next step.

Step 7: If CN is now on line and can be contacted by BS, BS sends a data-transmission-reply message, i.e., message 4, with OP_code=4 to SS. The format of the data-transmission-reply message (message 4) is:

OP_Code | Cerfun (AK 4,AK 5,AK 6)

If the CN is now off line, BS sends an Transmission-request-failure message, i.e., message 4, with OP_code=5 to SS. The message format reuses the one shown above.

Step 8: The SS on receipt of the message authenticates the message with the same process mentioned in step 6 with Cerfun(AK1,AK2,AK3) replaced by Cerfun(AK4,AK5,AK6). If the authentication fails, SS discards the fake message and waits for a message issued by the valid BS. If the authentication successes and OP_code=5, then SS terminates the communication. If the authentication successes and OP_code=4, then SS proceeds to the next step.

The Data Transmission Phase: This phase is involved to transmit data messages.

Step 9: If the plaintext of q bits in length can be partitioned into n I-bit segments, e.g., plaintext₀˜plaintextₙ₋₁, i.e.,

$$Plaintext = {plaintext}_{0} + {plaintext}_{1} + … + {plaintext}_{n - 1} , n \geq 1$$

$$where$$

$$n = ⌈ \frac{q}{l} ⌉ .$$

The encryption process is

ciphertextᵢ=(plaintextᵢ⊕NTEKⱼ)+TEKⱼ, 0≦i≦n−1, j=(i+m) mod 243, 0≦m≦242

and

Ciphertext=ciphertext₀+ciphertext₁+ . . . +ciphertextₙ₋₁,n≧1

SS sends the ciphertext as a data message to BS. The format of a data message from SS to BS is:

OP_Code | RHSEXOR(AK6,m)|EXOR(TEKm,NTEKm)|Ciphertext

Step 10: BS authenticates the message by comparing the self-calculated value of the traffic certification key EXOR (TEKm, NTEKm), and the value retrieved from the message. If they are not equal, BS discards the fake message and waits for the message issued by the valid SS. Otherwise it decrypts the ciphertext with the following process.

$$pla int exti = \{ \begin{matrix}( {ciphertext}_{i} - {TEK}_{j} ) ⊕ {NTEK}_{j} , & if {ciphertext}_{i} \geq {TEK}_{j} \\ ( {ciphertext}_{i} + \overline{{TEK}_{j}} + 1 ) ⊕ {NTEK}_{j} , & if {ciphertext}_{i} < {TEK}_{j} \\ where 0 \leq i \leq n - 1 , & j = ( i + m ) mod 243 , 0 \leq m \leq 242 ,\end{matrix} \\ and \\ Plaintext = {plaintext}_{0} + {plaintext}_{1} + … + {plaintext}_{n - 1} , n \geq 1$$

In the above description, when BS sends an authentication-success message(step 2) to SS and SS sends the ciphertext to the BS, BS and SS employ an Adder function as the data carrier.

The ciphertext transmitted between SS and BS is encrypted by a two dimension stream cipher technique, implying two different types of encryption operations are performed on the same plaintext and each different plaintext bytes are encrypted with different random codes. The cipher operation technique combining both features is called the two dimension stream cipher technique.

The present invention establishes a wireless communication system with mutual authentication between SS and BS in a wireless communication environment. To this end, the present invention has the following sub-functions, which are described individually as follows:

Sub-function (1): Encryption/Decryption Functions

1. Diffie-Hellman PKDS function:

DH(p,g,x)=g^{x} mod p, where p is a strong prime number, g is the primitive root of p, x is a random parameter, DH(p,g,x), p and x are of same size, such as 512, 1024 or 2048 bits.

2. HMAC(key), generating a Hash-based Message Authentication Code, is a hash function performed on a secret key to generate a message authentication code.

3. Exclusive OR function:

EXOR(x,y)=x y_{∘}

4. Right-Hand-Side Exclusive OR function:

RHS_EXOR(x,y)=RHS(x) y where RHS(x) is the right-hand-side of x and length of RHS(x) is equal to length of y_{∘}

5. Adder function:

ADR(x,y)=x+y where “+” is a binary adder which discards the carry of the most significant bits of x+y_{∘}

6. Certification function(Identity Authentication function):

Cerfun(x,y,z)=(x y)+z_{∘}

7. Decryption:

```
<a>y=x EXOR(x,y)
<b>y=RHS(x) RHS_EXOR(x,y)
<c>IADR(x,ADR(x,y))=y
    y=ADR(x,y)−x, if ADR(x,y) x
    y=ADR(x,y)+ x̅ +1, if ADR(x,y)<x
<d>ICerfun(x,y,z)=x
    x=(Cerfun(x,y,z)−z) y, if Cerfun(x,y,z) z
    x=(Cerfun(x,y,x)+ Z̅ +1) y, if Cerfun(x,y,x)<z
```

Sub-function (2): Data Carriers

When SS and BS have the common connection data, such as the Common Secret Keys owned by both SS and BS, it may be feasible to use the following method for securely carrying the random parameter RN from SS to BS, or carrying from BS to SS without the RN being stolen by hackers.

(1) Encryption: ADR(CSK,RN)

Decryption: RN=ADR(CSK,RN)−CSK, if ADR(CSK,RN) CSK

RN=ADR(CSK,RN)+ C̅S̅K̅+1, if ADR(CSK,RN)<CSK

(2) Method: Encrypting data into a ciphertext at the sender end, wirelessly transmitting the ciphertext to the recipient end, and then decrypting the ciphertext at the recipient end so as to securely delivering the random parameter RN through wireless channel to the recipient. Here ADR( )is the data carrier.

Sub-function (3): Mutual Authentication

In order to establish the mutual authentication mechanism between SS and BS, firstly SS and BS should have at least two connection data, such as CSK1 and CSK2, so that both of the following methods can complete the mutual authentication.

Method 1: Transmitting encrypted authentication data, such as EXOR(CSK1, CSK2) or ADR(CSK1, CSK2)

Because only SS and BS know CSK1 and CSK2, only SS and BS can complete the authentication. The hacker cannot complete the authentication process. However, the disadvantage of this method is that, CSK1 and CSK2 can be relatively easier to be cracked by hackers compared to the cracking of EXOR( ) and ADR( )

Method 2: Using Identity certification function Cerfun(CSK1, CSK2, CSK3)

The advantage of this method is using three random parameters CSK1, CSK2 and CSK3 to generate an identity certification code Cerfun(CSK1, CSK2, CSK3), so this method has excellent security. Its disadvantage is that, the sender and the recipient have to commit the three random parameters CSK1, CSK2, CSK3 as the connection data between the sender and the recipient before the authentication of wireless communication can be proceeded.

Sub-function (4): OP_code Table

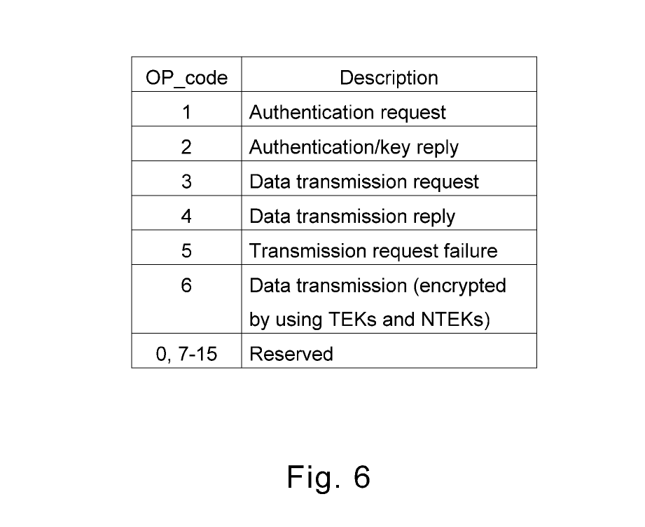

OP_code is a 4-bit control code, and the content of this code is shown in FIG. 6, which is an OP_code function lookup table of an embodiment of the present invention.

As describe above, the present invention fully complies with the three requirements for Patent right: innovation, progressivity and industrial availability. As for innovation and progressivity, the present invention integrates Diffie-Hellman PKDS, data carrier and mutual authentication mechanism, and establish a securely dynamic keys exchange system between SS and BS, such that, in a wireless communication environment, any wireless communication between SS and BS can achieve the mutual authentication, and all the keys and parameters used in wireless transmission are exposed only once, so as to enhance the security of wireless communication. As for the industrial availability, the product derived from the present invention should sufficiently satisfy the current market requirement.

The present invention has been disclosed in the above context with preferred embodiments. However, it should be appreciated by the skilled in the art that these embodiments are only used to describe the present invention, and should not be interpreted as limiting the scope of the present invention. It should be noted that the equivalent variation and replacement to the embodiments should all be encompassed within the scope of the present invention. Thus, the protection scope of the present invention should only be defined by the appended claims.

What is claimed is:

1. A method with dynamic keys for mutual authentication in wireless communication environment without prior authentication connection, said method comprises:
A subscriber station (SS) randomly generates a set of SS random numbers as SS private keys, and inputs the set of SS private keys into a Diffie-Hellman Public Key Distribution System (Diffie-Hellman PKDS) function to generate a set of SS public keys. The SS then transmits the set of SS public keys, Cert(SS) and a wireless communication authentication request to a BS.
The BS on receiving the wireless communication authentication request from the SS retrieves the PubKey(SS) from Cert(SS) and determines whether the HMAC(PubKey(SS)) sent by SS and HMAC(PubKey(SS)) calculated inside the BS are equal or not? If not, BS discards the fake message. Otherwise, BS further compares the N_{SS} sent by SS and the nonce of BS (N_{BS}) immediately. If N_{BS}−N_{SS} is greater than 30 seconds, then BS discards the suspected replay attack message. Otherwise BS randomly selects a set of BS random numbers as the BS private keys, and input the set of BS private keys into a Diffie-Hellman PKDS function to generate a set of BS public keys. Next the BS employs the set of SS public keys sent by SS and the BS private key to calculate and generate a set of Common Secret Key (CSK1, CSK2, CSK3). BS further calculates and generates a set of BS's first identity certification key (Cerfun(PubKey(SS), CSK1, CSK2)) from the retrieved set of Common Secret Key. After that the BS transmits an authentication success message and the BS's first identity certification key to the SS. Subsequently, the BS independently calculates and generates a set of BS Authentication Keys (AKs), a set of BS Traffic Encryption Keys (TEKs), and a set of BS New Traffic Encryption Keys (NTEKs);
The SS on receiving the message from the BS retrieves the OP_code from the message, and from the OP-code, the SS can realize that this is an authentication success message that contains the BS's first identity certification key, i.e., Cerfun(Pubkey(SS), CSK1, CSK2). Then the SS employs the SS private keys and the set of BS public keys sent by the BS to calculate and generate a set of SS Common Secret Keys, and further calculates and generates a SS's first identity certification key, i.e., Cerfun(Pubkey(SS), CSK1, CSK2). SS compares the calculated SS's first identity certification key with the BS's first identity certification key sent by the BS to see if there are equal or not. If yes, the SS will decode the data with the carrier ADR( )function to retrieve the parameters pre_AK1, pre_AK2 and pre_AK3 sent by the BS, and further independently calculate and generate a set of SS Authentication keys (AKs), a set of SS Traffic Encryption Keys (TEKs), and a set of SS New Traffic Encryption Keys (NTEKs). The SS transmits a data transmission request message that contains SS's second identity certification key, i.e., Cerfun(AK1, AK2, AK3), to the BS. The BS on receiving the data transmission request of the SS checks to see whether the SS's second identity certification key sent by the SS and a BS's second identity certification key calculated and generated inside the BS are equal or not. If they are equal, the BS returns a permit data transmission message and a BS's third identity certification key, i.e., Cerfun(AK4, AK5, AK6), to the SS. The SS on receiving the permit data transmission message that contains the BS's third identity certification key from the BS authenticates the BS by checking the BS's third identity certification key sent by the BS and a SS's third identity certification key calculated and generated inside the SS to see whether they are equal or not. If yes, the SS encrypts a plaintext data as a ciphertext, and sends the ciphertext and a SS authentication code EXOR(TEKm, NTEKm) to the BS. The BS on receiving the ciphertext and the SS authentication code from the SS authenticates whether the SS authentication code EXOR(TEKm, NTEKm) sent by SS and the BS authentication code EXOR(TEKm, NTEKm) calculated inside the BS are equal or not. If yes, the ciphertext will be decrypted into a plaintext.

2. The mutual authentication method of claim 1 integrates the nonce of SS, i.e., N_{SS}, and HMAC(PubKey(SS)) which together can effectively defenses the replay attack and protect the integrity of the transmitted message well.

3. In the mutual authentication method of claim 1, before the BS transmits an authentication success message to the SS and the SS transmits the ciphertext to the BS, both of the BS and the SS employ an Adder function as a data carrier. A sender, e.g., the SS (or the BS), encrypts the set of SS (or the BS) Common Secret Keys and a random parameter with the Adder function, and sends the encrypted data to a recipient, i.e., the BS (the SS), in a wireless manner, and the recipient will decrypt the data into the random parameter data also using the Adder function.

4. The mutual authentication method of claim 1, further provides an OP_code at the first field of each message transmitted between the BS and the SS, and the BS and the SS can then realize the function of the message through the OP_code, when the OP_code is a number with more than four bits.

5. In the mutual authentication method of claim 1, each plaintext transmitted between the BS and the SS is encrypted by a two dimension stream cipher technique, implying two different types of encryption operations are performed on the same plaintext data and each different plaintext bytes are encrypted with different random codes. The cipher operation technique combining both features is called the two dimension stream cipher technique.

6. In the mutual authentication method of claim 1, the SS checks to see whether the SS's first identity certification key, i.e., Cerfun(PubKey(SS), CSK1, CSK2), calculated by the SS and the BS's first identity certification key, i.e., Cerfun(PubKey(SS), CSK1, CSK2), sent by the BS are equal or not. If they are not equal, the SS discards the fake authentication/key reply message and waits for an authentication/key reply message issued by a valid BS.

7. In the mutual authentication method of claim 1, the BS checks to see whether the SS's second identity certification key, i.e., Cerfun(AK1, AK2, AK3), sent by the SS and the BS's second identity certification key, i.e., Cerfun(AK1, AK2, AK3), calculated inside the BS are equal or not. If they are not equal, the BS discards the fake data transmission request, and continues waiting for the data transmission request from the SS.

8. In the mutual authentication method of claim 1, the SS checks to see whether the BS's third identity certification key, i.e., Cerfun(AK4, AK5, AK6), sent by the BS and the SS's third identity certification key, i.e., Cerfun(AK4, AK5, AK6), calculated inside the SS are equal or not. If they are not equal, the SS discards the permit data transmission request message, and continues waiting for the permit data transmission request message from the BS.

9. In the mutual authentication method of claim 1, the BS on receiving the ciphertext transmitted by the SS authenticates whether the authentication code EXOR(TEKm, NTEKm) sent by the SS and the authentication code EXOR(TEKm, NTEKm) calculated and generated inside the BS are the same or not. If they are not the same, the BS discards the ciphertext transmitted by the SS, and continues waiting for the ciphertext transmission sent by the SS.
